(19) United States
(12) Patent Application Publication
(10) Pub. No.: US 2011/0047215 A1
(43) Pub. Date: Feb. 24, 2011

(54) DECENTRALIZED HIERARCHICALLY CLUSTERED PEER-TO-PEER LIVE STREAMING SYSTEM

(76) Inventors: Yang Guo, West Windsor, NJ (US); Chao Liang, Brooklyn, NY (US); Yong Liu, Brooklyn, NY (US)

Correspondence Address: Robert D. Shedd, Patent Operations;THOMSON Licensing LLC, P.O. Box 5312, Princeton, NJ, 08543-5312, US

(21) Appl. No.: 12/919,168

(22) PCT Filed: Feb. 27, 2008
(86) PCT No.: PCT/US08/02603

§ 371 Date: Oct. 29, 2010

(51) Int. Cl. G06F 15/16

(52) U.S. Cl. 709/204

(57) ABSTRACT

A method and apparatus are described including forwarding data in a transmission queue to a first peer in a same cluster, computing an average transmission queue size to a threshold, sending a signal to a cluster head based on a result of the comparison. A method and apparatus are also described including forwarding data in a transmission queue to a peer associated with an upper level peer, forwarding data in a playback buffer to a peer in a lower level cluster responsive to a first signal in a signal queue associated with the lower level cluster, determining if the playback buffer has exceeded a threshold for a period of time, sending a second signal to a source server based on a result of the determination.

### FIELD OF THE INVENTION

The present invention relates to network communications and, in particular, to streaming data in a peer-to-peer network.

### BACKGROUND OF THE INVENTION

The prior art shows that the maximum video streaming rate in a peer-to-peer (P2P) streaming system is determined by the video source server's capacity, the number of the peers in the system, and the aggregate uploading capacity of all peers. A centralized “perfect” scheduling algorithm was described in order to achieve the maximum streaming rate. However, the “perfect” scheduling algorithm has two shortcomings. First, it requires a central scheduler that collects the upload capacity information of all of the individual peers. The central scheduler then computes the rate of sub-streams sent from the source to the peers. In the “perfect” scheduling algorithm, the central scheduler is a single point/unit/device. As used herein, “/” denotes alternative names for the same or similar components or structures. That is, a “/” can be taken as meaning “or” as used herein. Moreover, peer upload capacity information may not be available and varies over time. Inaccurate upload capacity leads to incorrect sub-stream rates that would either under utilize the system bandwidth or over-estimate the supportable streaming rate.

A fully connected mesh between the server and all peers is required. In a P2P system that routinely has thousands of peers, it is unrealistic for a peer to maintain thousands of active P2P connections. In addition, the server needs to split the video stream into sub-streams, one for each peer. It will be challenging for a server to partition a video stream into thousands of sub-streams in real-time.

In an earlier application, PCT/US07/025,656, a hierarchically clustered P2P live streaming system was designed that divides the peers into small clusters and forms a hierarchy among the clusters. The hierarchically clustered P2P system achieves the streaming rate close to the theoretical upper bound. A peer need only maintain connections with a small number of neighboring peers within the cluster. The centralized “perfect” scheduling method is employed within the individual clusters.

In another earlier patent application PCT/US07/15246 a decentralized version of the “perfect” scheduling with peers forming a fully connected mesh was described.

### SUMMARY OF THE INVENTION

The present invention is directed towards a fully distributed scheduling mechanism for a hierarchically clustered P2P live streaming system. The distributed scheduling mechanism is executed at the source server and peer nodes. It utilizes local information and no central controller is required at the cluster level. Decentralized hierarchically clustered P2P live streaming system thus overcomes two major shortcomings of the original “perfect” scheduling algorithm.

The hierarchically clustered P2P streaming method of the present invention is described in terms of live video streaming. However, any form of data can be streamed including but not limited to video, audio, multimedia, streaming content, files, etc.

A method and apparatus are described including forwarding data in a transmission queue to a first peer in a same cluster, computing an average transmission queue size, comparing the average transmission queue size to a threshold, sending a signal to a cluster head based on a result of the comparison. A method and apparatus are also described including forwarding data in a transmission queue to a peer associated with an upper level peer, forwarding data in a playback buffer to a peer in a lower level cluster responsive to a first signal in a signal queue associated with the lower level cluster, determining if the playback buffer has exceeded a threshold for a period of time, sending a second signal to a source server based on a result of the determination. A method and apparatus are further described including forwarding data responsive to a signal in a signal queue to an issuer of the signal and forwarding data in a content buffer to a peer in a same cluster. Further described are a method and apparatus including determining if a source server can serve more data, moving the more data to a content buffer if the source server can serve more data, determining if a first sub-server is lagging significantly behind a second sub-server, executing the first sub-server's data handling process if the first sub-server is lagging significantly behind the second sub-server and executing the second sub-server's data handling process if the first sub-server is not lagging significantly behind the second sub-server.

### BRIEF DESCRIPTION OF THE DRAWINGS

The present invention is best understood from the following detailed description when read in conjunction with the accompanying drawings. The drawings include the following figures briefly described below where like-numbers on the figures represent similar elements:

FIG. 1 is a schematic diagram of a prior art P2P system using the “perfect” scheduling algorithm.

FIG. 2 is a schematic diagram of the Hierarchical Clustered P2P Streaming (HCPS) system of the prior art.

FIG. 3 shows the queueing model for a “normal” peer/node of the present invention.

FIG. 4 shows the queueing model for a cluster head of the present invention.

FIG. 5 shows the queueing model for the source server of the present invention.

FIG. 6 shows the architecture of a “normal” peer/node of the present invention.

FIG. 7 is a flowchart of the data handling process of a “normal” peer/node of the present invention.

FIG. 8 shows the architecture of a cluster head of the present invention.

FIG. 9 is a flowchart of the data handling process of a cluster head of the present invention.

FIG. 10 shows the architecture of the source server of the present invention.

FIG. 11A is a flowchart of the data handling process of a sub-server of the present invention.

FIG. 11B is a flowchart of the data handling process of the source server of the present invention.

### DETAILED DESCRIPTION OF THE PREFERRED EMBODIMENTS

A prior art scheme described a “perfect” scheduling algorithm that achieves the maximum streaming rate allowed by a P2P system. There are n peers in the system, and peer i's upload capacity is uᵢ, i=1, 2, . . . , n. There is one source (the server) in the system with an upload capacity of uₛ. Denote by r^{max} the maximum streaming rate allowed by the system, which can be expressed as:

$${r}^{max} = min \{ {u}_{s} , \frac{{u}_{s} + {\sum }_{i = 1}^{n} {u}_{i}}{n} \} \qquad ( 1 )$$

The value of

$$( {u}_{s} + {\sum }_{i = 1}^{n} {u}_{i} ) / n$$

is the average upload capacity per peer.

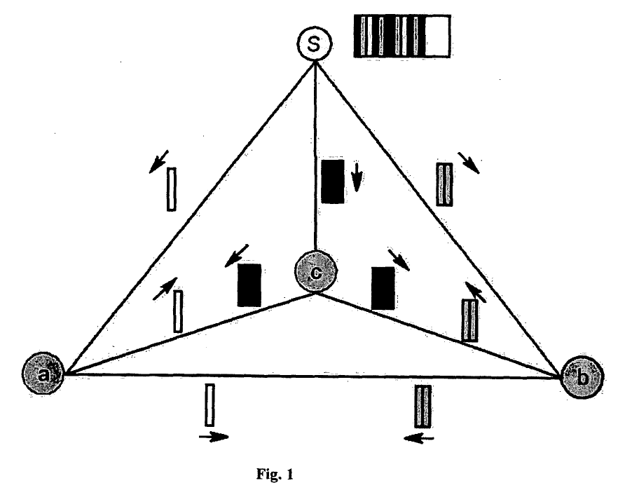

FIG. 1 shows an example how the different portions of data are scheduled among three heterogeneous nodes using the “perfect” scheduling algorithm of the prior art. There are three peers/nodes in the system. The source server has a capacity of 6 chunks per time-unit, where chunk is the basic data unit. The upload capacities of a, b and c are 2 chunks per time-unit, 4 chunks/time-unit and 6 chunks/time-unit, respectively. Suppose the peers all have enough downloading capacity, the maximum data/video rate can be supported by the system is 6 chunks/time-unit. To achieve that rate, the server divides the data/video chunks into groups of 6. Node a is responsible for uploading 1 chunk out of each group while nodes b and c are responsible for upload 2 and 3 chunks within each group. This way, all peers can download data/video at the maximum rate of 6 chunks/units. To implement such a “perfect” scheduling algorithm, each peer needs to maintain a connection and exchange data/video content with all other peers in the system. Additionally, the server needs to split the video stream into multiple sub-streams with different rates, one for each peer. A real practical P2P streaming system can easily have a few thousand of peers. With current operating systems, it is unrealistic for a regular peer to maintain thousands of concurrent connections. It is also challenging for a server to partition a data/video stream into thousands of sub-streams in real time.

The hierarchically Clustered P2P Streaming (HCPS) system of the previous invention supports a streaming rate approaching the optimum upper bound with short delay, yet is scalable to accommodate a large number of users/peers/nodes/clients in practice. In the HCPS of the previous invention, the peers are grouped into small size clusters and a hierarchy is formed among clusters to retrieve data/video from the source server. By actively balancing the uploading capacities among the clusters, and executing the “perfect” scheduling algorithm within each cluster, the system resources can be efficiently utilized.

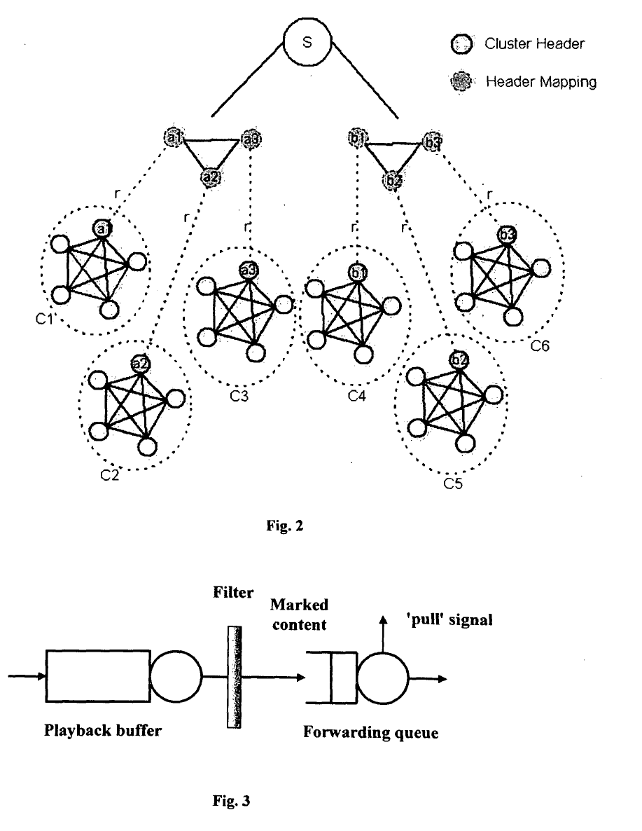

FIG. 2 depicts a two-level HCPS system. Peers/nodes are organized into bandwidth-balanced clusters, where each cluster consists of a small number of peers. In the current example, 30 peers are evenly divided into six clusters. Within each cluster, one peer is selected as the cluster head. Cluster head acts as the local data/video proxy server for the peers in its cluster. “Normal” peers maintain connections within the cluster but do not have to maintain connections with peers/nodes in other clusters. Cluster heads not only maintain connections with peers of the cluster they heads, they also participate as peers in an upper-level cluster from which data/video is retrieved. For instance, in FIG. 2, cluster heads of all clusters form two upper-level clusters to retrieve data/video from the data/video source server. In the architecture of the present invention, the source server distributes data/video to the cluster heads and peers in the upper level cluster. The exemplary two-level HCPS has the ability to support a large number of peers with minimal connection requirements on the server, cluster heads and normal peers.

While the peers within the same cluster could collaborate according to the “perfect” scheduling algorithm to retrieve data/video from their cluster head, the “perfect” scheduling employed in HCPS does not work well in practice. Described herein is a decentralized scheduling mechanism that works for the HCPS architecture of the present invention. The decentralized scheduling method of the present invention is able to serve a large number of users/peers/nodes, while individual users/peers/nodes maintain a small number of peer/node connections and exchange data with other peers/nodes/users according to locally available information.

There are three types of nodes/peers in the HCPS system of the present invention: source server, cluster head, and “normal” peer. The source server is the true server of the entire system. The source server serves one or multiple top-level clusters. For instance, the source server in FIG. 2 serves two top-level clusters. A cluster head participates in two clusters: upper-level cluster and lower-level cluster. A cluster head behaves as a “normal” peer in the upper level cluster and obtains the data/video content from the upper level cluster. That is, in the upper level cluster the cluster head receives streaming content from the source server/cluster head and/or by exchanging data/streaming content with other cluster heads (nodes/peers) in the cluster. The cluster head serves as the local source for the lower-level cluster. Finally, a “normal” peer is a peer/node that participates in only one cluster. It receives the streaming content from the cluster head and exchanges data with other peers within the same cluster. In FIG. 2, peers a1, a2, a3, and b1, b2, b3 are cluster heads. They act as the source (so behave like source servers) in their respective lower-level clusters. Meanwhile, cluster heads a1, a2, a3, and the source server form one top-level cluster. Cluster heads b1, b2, b3, and the source server form the other top-level cluster. It should be noted that an architecture including more than two-levels is possible and a two-level architecture is used herein in order to explain the principles of the present invention.

Next the decentralized scheduling mechanism, the queuing model, and the architecture for a “normal” peer (at the lower level), a cluster head, and the source server, are respectively described.

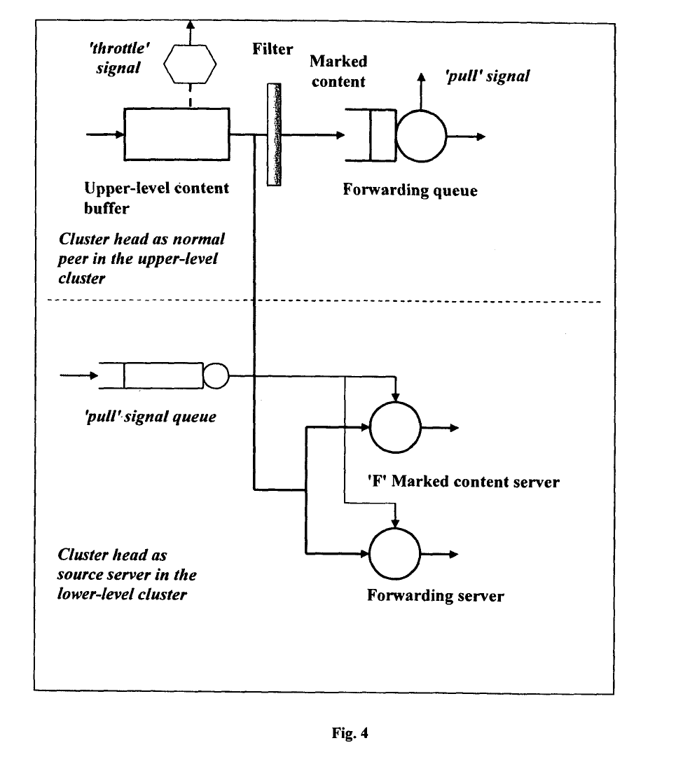

As shown in FIG. 3, a “normal” peer/node (lower level) maintains a playback buffer that stores all received streaming content. The “normal” peer/node also maintains a forwarding queue that stores the content to be forwarded to all other “normal” peers/nodes within the cluster. The content obtained from the cluster head acting as the source is marked as either “F” or “NF” content. “F” represents that the content needs to be relayed to other “normal” peers/nodes within the cluster. “NF” means that the content is intended for this peer only and no forwarding is required. The content received from other “normal” peers is always marked as ‘NF’ content. The received content is first saved into the playback buffer. The ‘F’ marked content marked is then stored into the forwarding queue and to be forwarded to other “normal” peers within the cluster. Whenever the forwarding queue becomes empty, the “normal” peer issues a “pull” signal to the cluster head requesting more content.

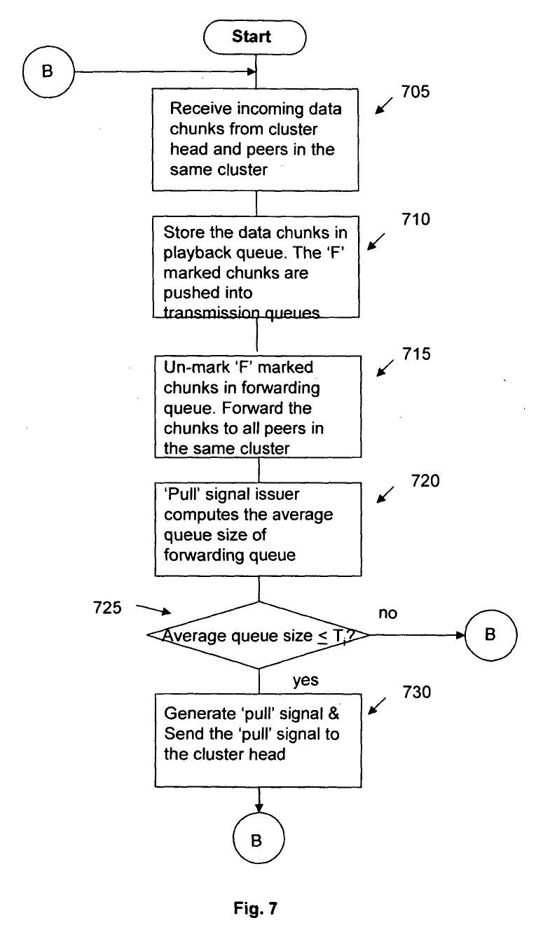

FIG. 6 illustrates the architecture of a normal peer. The receiving process handles the incoming traffic from cluster head and other “normal” peers. The received data is then handed over to data handling process. The data handling process includes a “pull” signal issuer, a packet handler and a playback buffer. Data chunks stored in the playback buffer are rendered such that a user (at a peer/node) can view the streamed data stored in the playback buffer as a continuous program. The data and signals that need to be sent to other nodes are stored in the transmission queues. The transmission process handles the transmission of data and signals in the transmission queues. The receiving process, data handling process and transmission process may each be separate processes/modules within a “normal” peer or may be a single process/module. Similarly, the process/module that issues a “pull” signal, the process/module that handles data packets and the playback buffer may be implemented in a single process/module or separate processes/modules. The processes/modules may be implemented in software with the instructions stored in a memory of a processor or may be implemented in hardware or firmware using application specific integrated circuits (ASICs), field programmable gate arrays (FPGAs) etc. The queues and buffers described may be implemented in storage, which may be an integral part of a processor or may be separate units/devices. The peer-to-peer connections can be established over wired network, wireless network, or the combination of them.

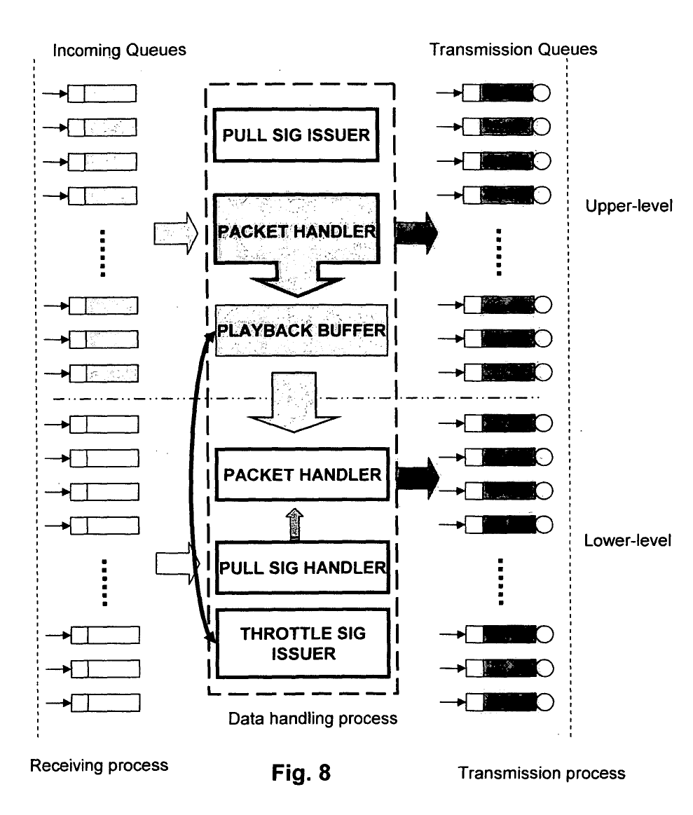

FIG. 7 is the flow chart describes the method of the present invention at a “normal” peer/node. At 705 the “normal” peer receives data chunks at the receiving process. The receiving process received the incoming data chunks from the cluster head and/or other “normal” peers/nodes in the cluster. The data chunks are then passed to the data handling process and are stored by the packet handler of data handling process in the playback buffer at 710. The “F” marked data chunks are also forwarded by the packet handler to the transmission process for storing into the transmission queues. The “F” marked data chunks are un-marked in the transmission queues and forwarded to all peers/nodes within the same cluster at 715. The “pull” signal issuer calculates the average queue size of the transmission queue at 720. A test is performed at 725 to determine if the average queue size is less than or equal to a predetermined threshold value. If the average queue size is less than or equal to the predetermined threshold value then the “pull” signal issuer generates a “pull” signal and sends the pull signal to the cluster head in order to obtain more content/data at 730. If the average queue size is greater than the predetermined threshold value then processing proceeds to 705.

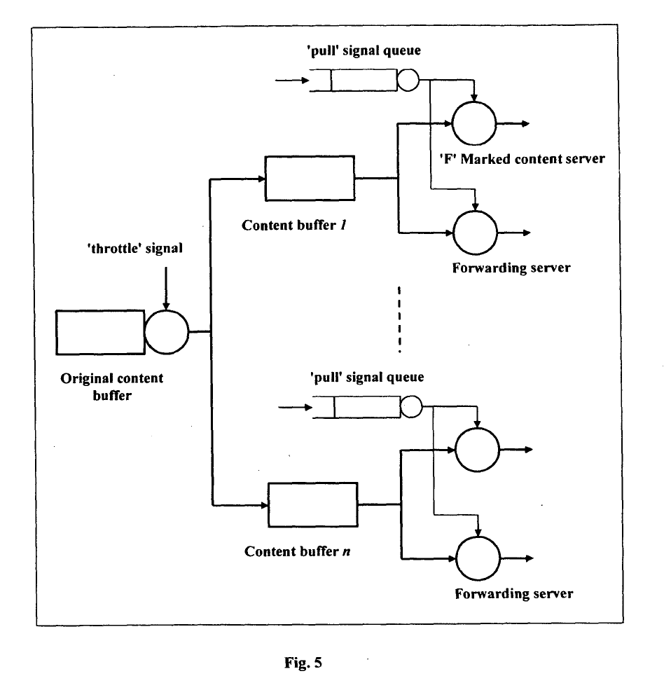

Cluster heads joins two clusters. That is, a cluster head will be a member of two clusters concurrently. A cluster head behaves as a “normal” peer in the upper-level cluster and as the source node in the lower-level cluster. The queuing model of the cluster head, thus, is two levels as well, as shown in FIG. 4. As a “normal” node in the upper-level cluster, the cluster head receives the content from peers within the same cluster as well as from the source server. It relays the ‘F’ marked content to other peers in the same upper level cluster and issues “pull” signals to the source server when it needs more content. At the upper level, the cluster head also may issue a throttle signal to the source server, which is described in more detail below.

Still referring to FIG. 4, as the source in the lower-level cluster, the cluster head has two queues: a content queue and a signal queue. The content queue is a multi-server queue with two servers: an “F” marked content server and a forwarding server. Which server to use depends on the status of the signal queue. Specifically, if there is ‘pull’ signal in the signal queue, a small chunk of content is taken off content buffer, marked as “F”, and served by the “F” marked content server to the peer that issued the “pull” signal. The “pull” signal is then removed from the “pull” signal queue. On the other hand, if the signal queue is empty, the server takes a small chunk of content (data chunk) from the content buffer and transfers it to the forwarding server. The forwarding server marks the data chunk as “NF” and sends it to all peers in the same cluster.

A cluster head's upload capacity is shared between upper-level cluster and lower level cluster. In order to achieve the maximum streaming rate allowed by a dHCPS system, the forwarding server and “F” marked content server in the lower-level cluster always has priority over the forwarding queue in the upper-level cluster. Specifically, the cluster head will not serve the forwarding queuing in the upper-level until the content in the playback buffer for the lower-level cluster has been fully served.

A lower-level cluster can be overwhelmed by the upper-level cluster if the streaming rate supported at the upper-level cluster is larger than the streaming rate supported by the lower-level cluster. If the entire upload capacity of the cluster head has been used in the lower-level, yet the content accumulated in the upper-level content buffer continues to increase, it can be inferred that the current streaming rate is too large to be supported by the lower-level cluster. A feedback mechanism at the playback buffer of the cluster head is introduced. The playback buffer has a content rate estimator that continuously estimates the incoming streaming rate. A threshold is set at the playback buffer. If the received content is over the threshold for an extended period of time, say t, the cluster head will send a throttle signal together with the estimated incoming streaming rate to the source server. The signal reports to the source server that the current streaming rate surpasses the rate that can be consumed by the lower-level cluster headed by this node. The source server responds to the ‘throttle’ signal and acts correspondingly to reduce the streaming rate. The source server may choose to respond to the “throttle” signal and acts correspondingly to reduce the streaming rate. As an alternative, the source server may choose not to slow down the current streaming rate. In that case, the peer(s) in the cluster that issued the throttle signal will experience degraded viewing quality such as frequent frame freezing. However, the quality degradation does not spill over to other clusters.

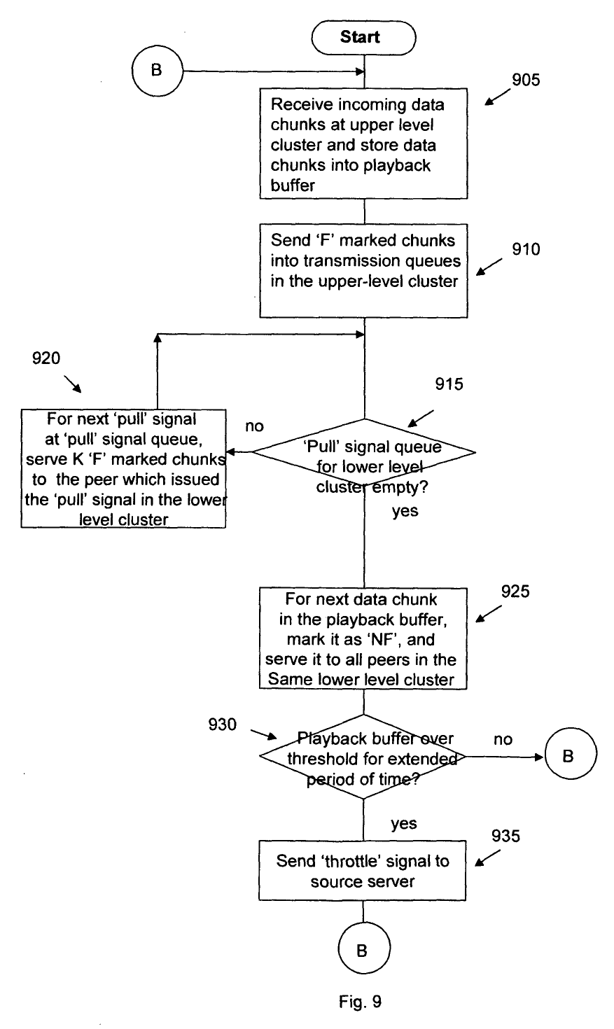

FIG. 8 depicts the architecture of a cluster head. The receiving process handles the incoming traffic from both upper-level cluster and lower-level cluster. The received data is then handed over to data handling process. The data handling process for the upper level includes a packet handler, playback buffer and “pull” signal issuer. Data chunks stored in the playback buffer are rendered such that a user (at a cluster head) can view the streamed data stored in the playback buffer as a continuous program. The data handling process for the lower level includes a packet handler, a “pull” signal handler and a throttle signal issuer. The incoming queues for low-level cluster only receive ‘pull’ signals. The data and signals that need to be sent to other nodes are stored in the transmission queues. The transmission process handles the transmission of data in the transmission queues. The data chunks in the upper level cluster queues are transmitted to other cluster heads/peers in the upper-level cluster, and the data chunks in the lower level transmission queues are transmitted to the peers in the lower level cluster for which this cluster head is the source. The transmission process gives higher priority to the traffic in the lower-level cluster.

The receiving process, data handling process and transmission process may each be separate processes/modules within a cluster head or may be a single process/module. Similarly, the process/module that issues a “pull” signal, the process/module that handles packets and the playback buffer may be implemented in a single process/module or separate processes/modules. The processes/modules may be implemented in software with the instructions stored in a memory of a processor or may be implemented in hardware or firmware using application specific integrated circuits (ASICs), field programmable gate arrays (FPGAs) etc. The queues and buffers described may be implemented in storage, which may be an integral part of a processor or may be separate units/devices.

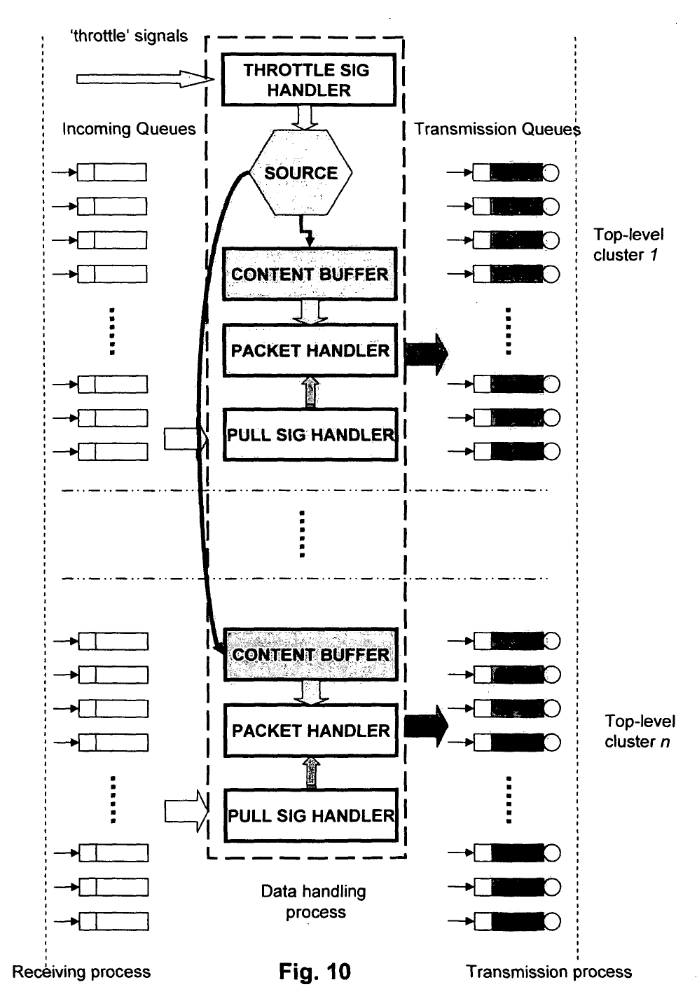

FIG. 9 is the flow chart describes the process of data handling for a cluster head. At 905 the cluster head receives incoming data chunks (upper level incoming queues) and stores the received incoming data chunks in its playback buffer. The packet handler of the upper level data handling process stores the data chunks marked “F” into the transmission queues in the upper level cluster of the transmission process at 910. The “F” marked data chunks are to be forwarded to other cluster heads and peers in the same cluster. The packet handler of the lower level data handling process inspects the signal queue and if there is a “pull” signal pending at 915, the packet handler of the lower level data handling process removes the pending “pull” signal from the “pull” signal queue and serves K “F′ marked data chunks to the “normal” peer in the lower level cluster that issued the “pull” signal at 920. Receiving a “pull” signal from a lower level cluster indicates that the lower level cluster's queue is empty or that the average queue size is below a predetermined threshold. The process then loops back to 915. If the “pull” signal queue is empty then the next data chunk in the playback buffer is marked as “NF” and served to all peers in the same lower level cluster at 925. A test is performed at 930 to determine if the playback buffer has been over a threshold for an extended predetermined period of time, t. If the playback buffer has been over a threshold for an extended predetermined period of time, t, then a throttle signal is generated and sent to the source server at 935. If the playback buffer has not been over a threshold for an extended predetermined period of time, t, then processing proceeds to 905.

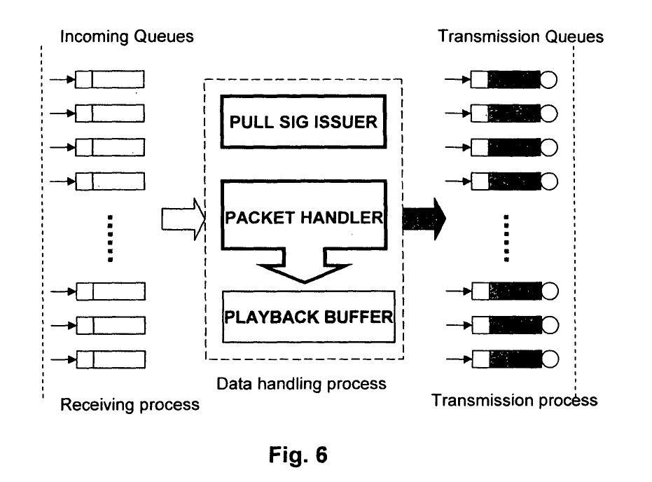

Referring to FIG. 5, the source server in HCPS system may participate in one or multiple top-level clusters. The source server has one sub-server for each top-level cluster. Each sub-server includes two queues: content queue and signal queue. The content queue is a multi-server queue with two servers: ‘F’ marked content server and forwarding server. Which server to use depends on the status of the signal queue. Specifically, if there is ‘pull’ signal in the signal queue, a small chunk of content is taken off content buffer, marked as “F”, and served by the ‘F’ marked content server to the peer that issued the ‘pull’ signal. The ‘pull’ signal is thereby consumed (and removed from the signal queue). On the other hand, if the signal queue is empty, the server takes a small chunk of content off the content buffer and hands it to the forwarding server. The forwarding server marks the chunk as ‘NF’ and sends it to all peers in the cluster.

The source server maintains an original content queue that stores the data/streaming content. It also handles the ‘throttle’ signals from the lower level clusters and from cluster heads the source server serves at the top-level clusters. The server regulates the streaming rate according to the ‘throttle’ signals from the peers/nodes. The server's upload capacity is shared among all top-level clusters. The bandwidth sharing follows the following rules:

The cluster that lags behind other clusters significantly (by a threshold in terms of content queue size) has the highest priority to use the upload capacity.

If all content queues are of the same/similar size, then clusters/sub-servers are served in a round robin fashion.

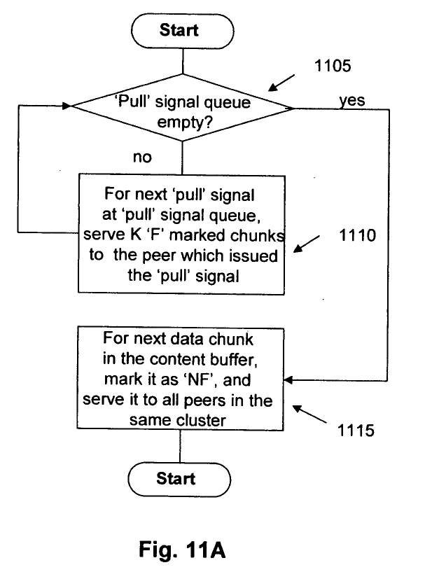

FIG. 10 depicts the architecture of the source server. The receiving process handles the incoming ‘pull’ signals from the members of the top-level clusters. The source server has a throttle signal handler. The data/video source is pushed into sub-servers' content buffers. A throttle signal may hold back such data pushing process, and change the streaming rate to the rate suggested by the throttle signal. The data handling process for each sub-server includes a packet handler and a “pull” signal handler. Upon serving a ‘pull’ signal, data chunks in the sub-server's content buffer are pushed into the transmission queue for the peer that issues the ‘pull’ signal. If the “pull” signal queue is empty, a data chunk is pushed into the transmission queues to all peers in the cluster. The transmission process handles the transmission of data in the transmission queues in a round robin fashion. The receiving process, data handling process and transmission process may each be separate processes/modules within the source server or may be a single process/module. Similarly, the process/module that issues a “pull” signal, the process/module that handles packets and the playback buffer may be implemented in a single process/module or separate processes/modules. The processes/modules may be implemented in software with the instructions stored in a memory of a processor or may be implemented in hardware or firmware using application specific integrated circuits (ASICs), field programmable gate arrays (FPGAs) etc. The queues and buffers described may be implemented in storage, which may be an integral part of a processor or may be separate units/devices.

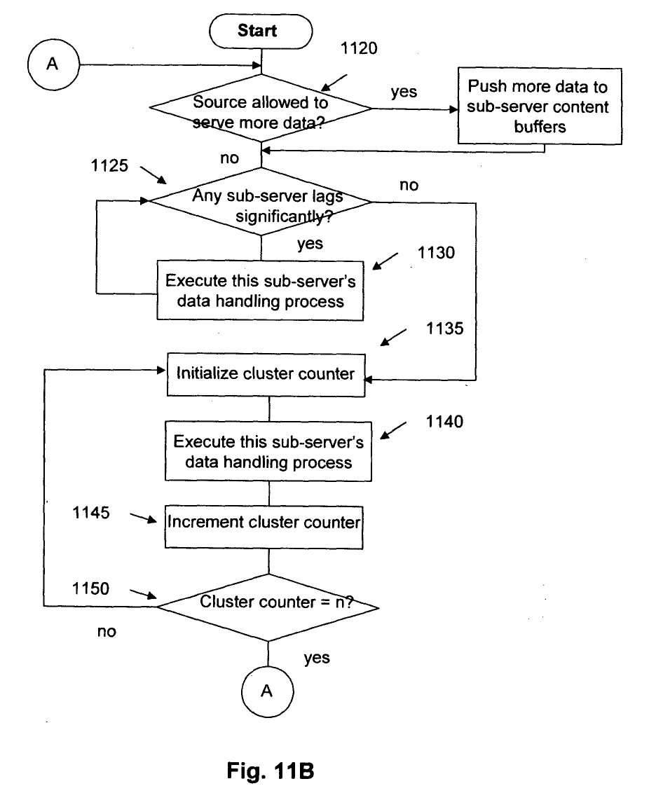

FIG. 11A is the flow chart describes the data handling process of the sub-server. In this exemplary implementation, the sub-server data handling process inspects the signal queue and if there is a “pull” signal pending at 1105, the packet handler removes the pending “pull” signal from the “pull” signal queue and serves K “F” marked data chunks to the peer that issued the “pull” signal at 1110. The process then loops back to 1105. If the “pull” signal queue is empty then the next data chunk in the playback buffer is marked as “NF” and served to all peers in the same cluster at 1115.

FIG. 11B is the flow chart describes the data handling process of the source server. A test is performed at 1120 to determine if the source server can send/serve more data to the peers headed by the source server. More data are pushed into sub-servers' content buffers if allowed at 1123. At 1125, the sub-server that lags significantly is identified according to the bandwidth sharing rule described above. The identified sub-server gets to run its data handling process first at 1130 and thus put more data chunks into transmission queue. Since transmission process will treat all transmission queues fairly, the sub-server that stores more data chunks into transmission queues get to use more bandwidth. The process then loops back to 1125. If no sub-server significantly lags behind, the process proceeds to 1135 and the cluster counter is initialized. The cluster counter is initialized to zero. The cluster counter may be initialized to one, in which case the test at 1150 would be against n+1. In yet another alternative embodiment the cluster counter may be initialized to the highest numbered cluster first and decremented. Counter initialization and incrementation or decrementation is well known in the art. The data handling process of the corresponding sub-server is executed at 1140. The cluster counter is incremented at 1145 and a test is performed at 1150 to determine if the last cluster head has been served in this round of service. If the last cluster head has been served in this round of service, then processing looks back to 1120.

The invention describe herein can achieve the maximum/optimal streaming rate allowed by the P2P system with the specific peer-to-peer overlay topology. If a constant-bit-rate (CBR) video is streamed over such a P2P system, all peers/users can be supported as long as the constant bit rate is smaller than the maximum supportable streaming rate.

The invention described herein does not assume any knowledge of the underlying network topology or the support of a dedicated network infrastructure such as in-network cache proxies or CDN (content distribution network) edge servers. If such information or infrastructure support is available, the decentralized HCPS (dHCPS) of the present invention is able to take advantage of such and deliver better user quality of experience (QoE). For instance, if the network topology is known, dHCPS can group the close-by peers into the same cluster hence reduce the traffic load on the underlying network and shorten the propagation delays. As another example, if in-network cache proxies or CDN edge servers are available to support the live streaming, dHCPS can use them as cluster heads since this dedicated network infrastructure typically has more upload capacity and are less likely to leave the network suddenly.

It is to be understood that the present invention may be implemented in various forms of hardware (e.g. ASIC chip), software, firmware, special purpose processors, or a combination thereof, for example, within a server, an intermediate device (such as a wireless access point, a wireless router, a set-top box, or mobile device). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method of operating a peer in a hierarchically clustered peer-to-peer live streaming network, said method comprising:
forwarding data in a transmission queue to a first peer, wherein said peer, said first peer and a second peer are all members of a same cluster;
computing an average transmission queue size;
comparing said average transmission queue size to a threshold; and
sending a signal to a cluster head based on a result of said comparison.

2. The method according to claim 1, further comprising:
receiving said data; and
storing said received data to be forwarded into said transmission queue; wherein said received data is from one of said cluster head and said second peer in the same cluster.

3. The method according to claim 2, further comprising:
storing said received data into a buffer for storing said received data to be rendered; and
rendering said data stored in said buffer.

4. The method according to claim 1, wherein said signal is an indication that additional data is needed by said transmission queue.

5. An apparatus operating as a peer in a hierarchically clustered peer-to-peer live streaming network, comprising:
means for forwarding data in a transmission queue to a first peer, wherein said peer, said first peer and a second peer are all members of a same cluster;
means for computing an average transmission queue size;
means for comparing said average transmission queue size to a predetermined threshold; and
means for sending a signal to a cluster head based on a result of said comparing means.

6. The apparatus according to claim 5, further comprising:
means for receiving said data; and
means for storing said received data to be forwarded into said transmission queue, wherein said received data is from one of said cluster head and said second peer in the same cluster.

7. The apparatus according to claim 6, further comprising:
means for storing said received data into a buffer for storing said received data to be rendered; and
means for rendering said data stored in said buffer.

8. The apparatus according to claim 5, wherein said signal is an indication that additional data is needed by said transmission queue.

9. A method of operating a cluster head in a hierarchically clustered peer-to-peer live streaming network, said method comprising:
forwarding data in a transmission queue to a peer associated with a an upper level cluster;
forwarding data in a buffer, said buffer for storing data to be rendered, to a peer in a lower level cluster responsive to a first signal in a signal queue associated with said lower level cluster;
determining if said buffer has exceeded a threshold for a period of time; and
sending a second signal to a server based on a result of said determining step, wherein said server serves as a source for source data stored therein.

10. The method according to claim 9, further comprising:
receiving data;
storing said received data into said buffer; and
rendering said received data stored in said buffer.

11. The method according to claim 9, wherein said received data is from one of said server and a second cluster head, wherein said second cluster head and said source server are members of a same upper level cluster.

12. The method according to claim 9, wherein said first signal is an indication that additional data is needed.

13. The method according to claim 9, wherein said second signal is an indication that a first rate at which data is being forwarded exceeds a second rate at which data can be used.

14. An apparatus operating as a cluster head in a hierarchically clustered peer-to-peer live streaming network, comprising:
means for forwarding data in a transmission queue to a peer associated with an upper level cluster;
means for forwarding data in a buffer, said buffer for storing data to be rendered, to a peer in a lower level cluster responsive to a first signal in a signal queue associated with said lower level cluster;
means for determining if said buffer has exceeded a threshold for a period of time; and
means for sending a second signal to a server based on a result of said means for determining, wherein said server serves as a source for data stored therein.

15. The apparatus according to claim 14, further comprising:
means for receiving data;
means for storing said received data into said buffer; and
means for rendering said received data stored in said buffer.

16. The apparatus according to claim 14, wherein said received data is from one of said server and a second cluster head, wherein said second cluster head and said source server are members of said same upper level cluster.

17. The apparatus according to claim 14, wherein said first signal is an indication that additional data is needed.

18. The apparatus according to claim 14, wherein said second signal is an indication that a first rate at which data is being forwarded exceeds a second rate at which data can be used.

19. A method of operating a sub-server in a hierarchically clustered peer-to-peer live streaming network, said method comprising:
forwarding data responsive to a signal in a signal queue to an issuer of said signal; and
forwarding data stored in a buffer to all peers, wherein all peers are members of a same cluster.

20. An apparatus operating as a sub-server in a hierarchically clustered peer-to-peer live streaming network, comprising:
means for forwarding data responsive to a signal in a signal queue to an issuer of said signal; and
means for forwarding data stored in a buffer to all peers, wherein all peers are members of a same cluster.

21-22. (canceled)
